(19) United States
(12) Patent Application Publication
(10) Pub. No.: US 2012/0045170 A1
(43) Pub. Date: Feb. 23, 2012

(54) OPTICAL WAVEGUIDE FOR TOUCH PANEL

(75) Inventors: Naoki Shibata, Osaka (JP); Toshiki Naito, Osaka (JP)

(73) Assignee: NITTO DENKO CORPORATION, Osaka (JP)

(21) Appl. No.: 13/207,926

(22) Filed: Aug. 11, 2011

(30) Foreign Application Priority Data
Aug. 18, 2010 (JP) 2010-183230

(51) Int. Cl. G02B 6/32

(52) U.S. Cl. 385/33

(57) ABSTRACT

An optical waveguide for a touch panel is capable of causing light beams emitted from a light-emitting optical waveguide section to enter a light-receiving optical waveguide section even when warpage or distortion occurs. Edges of an over cladding layer covering an end surface of a core for emitting a light beams and an end surface of a core for receiving the light beams respectively are configured in the form of light-emitting and light-receiving lens portions each having an outwardly-bulging arcuately curved surface as seen in vertical sectional view. The light-emitting lens portion has one of the following configurations: a configuration in which a light beam emitted from the light-emitting lens portion is adapted to diffuse in the direction of the height of the light-emitting lens portion; and a configuration in which the height of the light-emitting lens portion is less than that of the light-receiving lens portion.

### BACKGROUND OF THE INVENTION

1. Field of the Invention

The present invention relates to an optical waveguide for a touch panel which is used as a detection means for detecting a finger touch position and the like in a touch panel.

2. Description of the Related Art

A touch panel is an input device for operating an apparatus by directly touching a display screen of a liquid crystal display and the like with a finger, a purpose-built stylus and the like. The touch panel includes a display that displays operation details and the like, and a detection means that detects the position (coordinates) of a portion of the display screen of the display touched with the finger and the like. Information indicating the touch position detected by the detection means is sent in the form of a signal to the apparatus, which in turn performs an operation and the like displayed on the touch position. Examples of the apparatus employing such a touch panel include ATMs in banking facilities, ticket vending machines in stations, and portable game machines.

A detection means employing optical waveguides has been proposed as the detection means that detects the finger touch position and the like in the aforementioned touch panel, as disclosed in, for example, Japanese Published Patent Application No. 2010-15247. Specifically, as shown in FIG. 6, the touch panel includes a light-emitting optical waveguide A₀ provided on one side of a display screen of a display 61 of a rectangular plan configuration, and a light-receiving optical waveguide B₀ provided on the other side of the display screen of the display 61. A light-emitting element (not shown) is connected to the light-emitting optical waveguide A₀, and a light-receiving element (not shown) is connected to the light-receiving optical waveguide B₀. The light-emitting optical waveguide A₀ divides a light beam emitted from the light-emitting element into multiple light beams. The optical waveguide A₀ includes a light-emitting section which emits the multiple light beams S₀ parallel to the display screen of the display 61 toward the other side of the display screen. The light-receiving optical waveguide B₀ includes a light-receiving section which receives the emitted light beams S₀. These optical waveguides A₀ and B₀ cause the emitted light beams S₀ to travel in a lattice form on the display screen of the display 61. When a portion of the display screen of the display 61 is touched with a finger in this state, the finger blocks some of the emitted light beams S₀. The light-receiving element connected to the light-receiving optical waveguide B₀ senses a light blocked portion to thereby detect the position (coordinates) of the portion touched with the finger. It should be noted that the light beams S₀ emitted from the light-emitting section of the light-emitting optical waveguide A₀ are restrained from diffusing (diverging) along a plane perpendicular to the display screen of the display 61 (in a vertical direction) by a lens portion 70A provided in the light-emitting section to become parallel light beams. In FIG. 6, the reference numeral 72 designates an under cladding layer, 73 designates cores, and 74 designates an over cladding layer.

### SUMMARY OF THE INVENTION

The touch panel including the optical waveguides A₀ and B₀, however, has failed to detect the finger touch position and the like in some instances. Warpage or distortion in locations where the optical waveguides A₀ and B₀ are provided results in warpage or distortion in the optical waveguides A₀ and B₀ themselves, which in turn prevents the light beams S₀ emitted from the light-emitting optical waveguide A₀ from entering the light-receiving optical waveguide B₀. The touch panel including the optical waveguides A₀ and B₀ still has room for improvement in this regard.

An optical waveguide for a touch panel is provided which is capable of causing light beams emitted from a light-emitting optical waveguide section to enter a light-receiving optical waveguide section even when warpage or distortion occurs in the optical waveguide itself.

The optical waveguide for a touch panel comprises: cores; and an over cladding layer provided to cover the cores, the optical waveguide being provided along the periphery of a display screen of a display of a touch panel, the cores including a light-emitting core for emitting a light beam and a light-receiving core for receiving the light beam, the light-emitting core having an end surface positioned on one side of the display screen of the display, the light-receiving core having an end surface positioned on the other side of the display screen of the display, the over cladding layer including a first edge covering the end surface of the light-emitting core and configured in the form of a light-emitting lens portion having an outwardly-bulging arcuately curved surface as seen in vertical sectional view, and a second edge covering the end surface of the light-receiving core and configured in the form of a light-receiving lens portion having an outwardly-bulging arcuately curved surface as seen in vertical sectional view, the light-emitting lens portion having one of the following configurations: a first configuration in which a light beam emitted from the light-emitting lens portion is adapted to diffuse in the direction of the height of the light-emitting lens portion; and a second configuration in which the height of the light-emitting lens portion is less than that of the light-receiving lens portion.

The optical waveguide is designed so that a light beam emitted from the light-emitting lens portion is diffused (diverged) in the direction of the height of the light-emitting lens portion or so that the height of the light-emitting lens portion is less than that of the light-receiving lens portion (in other words, so that the height of the light-receiving lens portion is greater than that of the light-emitting lens portion). Thus, if warpage or distortion occurs in the optical waveguide itself, the optical waveguide enables the light-receiving lens portion to lie within a light-receiving region, thereby causing the light beam emitted from the light-emitting lens portion to enter the light-receiving lens portion. Of course, the optical waveguide is capable of causing a light beam emitted from the light-emitting lens portion to enter the light-receiving lens portion when neither the warpage nor the distortion occurs.

Preferably, the first configuration of the light-emitting lens portion satisfies

M=H1×(1+a×L/100)

0<a≦5

H1=H2

where H1 is the height of the light-emitting lens portion in millimeters, H2 is the height of the light-receiving lens portion in millimeters, L is a distance between edges of the light-emitting and light-receiving lens portions in millimeters, and M is a vertical width of a light beam emitted from the light-emitting lens portion as measured at the edge of the light-receiving lens portion in millimeters. In this case, the light beam emitted from the light-emitting lens portion is adapted to diffuse in the direction of the height of the light-emitting lens portion so that the vertical width (M) of the light beam is greater than 1.0 times the height (H1) of the light-emitting lens portion and is not greater than 1.5 times the height (H1) as measured at a position spaced a distance of ten times the height (H1) apart from the edge of the light-emitting lens portion, for example. The vertical width (M) of the light beam is optimized while warpage or distortion is accommodated.

Preferably, the second configuration of the light-emitting lens portion satisfies

H2=H1×(1+a×L/100)

0<a≦5

H1=M

where H1 is the height of the light-emitting lens portion in millimeters, H2 is the height of the light-receiving lens portion in millimeters, L is a distance between edges of the light-emitting and light-receiving lens portions in millimeters, and M is a vertical width of a light beam emitted from the light-emitting lens portion as measured at the edge of the light-receiving lens portion in millimeters. In this case, for example, when the distance (L) between the edges of the light-emitting and light-receiving lens portions is ten times the height (H1) of the light-emitting lens portion, the height (H2) of the light-receiving lens portion is greater than the height (H1) of the light-emitting lens portion so as to be greater than 1.0 times the height (H1) and to be not greater than 1.5 times the height (H1). The height (H2) of the light-receiving lens portion is optimized while warpage or distortion is accommodated.

Preferably, the vertical width of a light beam emitted from the light-emitting lens portion is set in consideration for a distance from a light-emitting surface of the light-emitting core to the edge of the light-emitting lens portion, and the radius of curvature of the arcuately curved surface of the light-emitting lens portion. In this case, the optimization of the vertical width of the light beam is achieved more easily.

### BRIEF DESCRIPTION OF THE DRAWINGS

FIG. 1A is a plan view schematically showing an optical waveguide for a touch panel according to a first preferred embodiment.

FIG. 1B is a view, on an enlarged scale, schematically showing an end portion of a core enclosed within a circle E of FIG. 1A.

FIG. 1C is a schematic sectional view, on an enlarged scale, taken along the line X-X of FIG. 1A.

FIG. 2 is a perspective view schematically showing a touch panel including the optical waveguide.

FIGS. 3A to 3D and FIGS. 4A to 4C are views schematically illustrating a method of manufacturing the optical waveguide.

FIG. 5 is a sectional view schematically showing an optical waveguide for a touch panel according to a second preferred embodiment.

FIG. 6 is a sectional view schematically showing a conventional touch panel.

### DETAILED DESCRIPTION OF THE INVENTION

Preferred embodiments according to the present invention will now be described in detail with reference to the drawings.

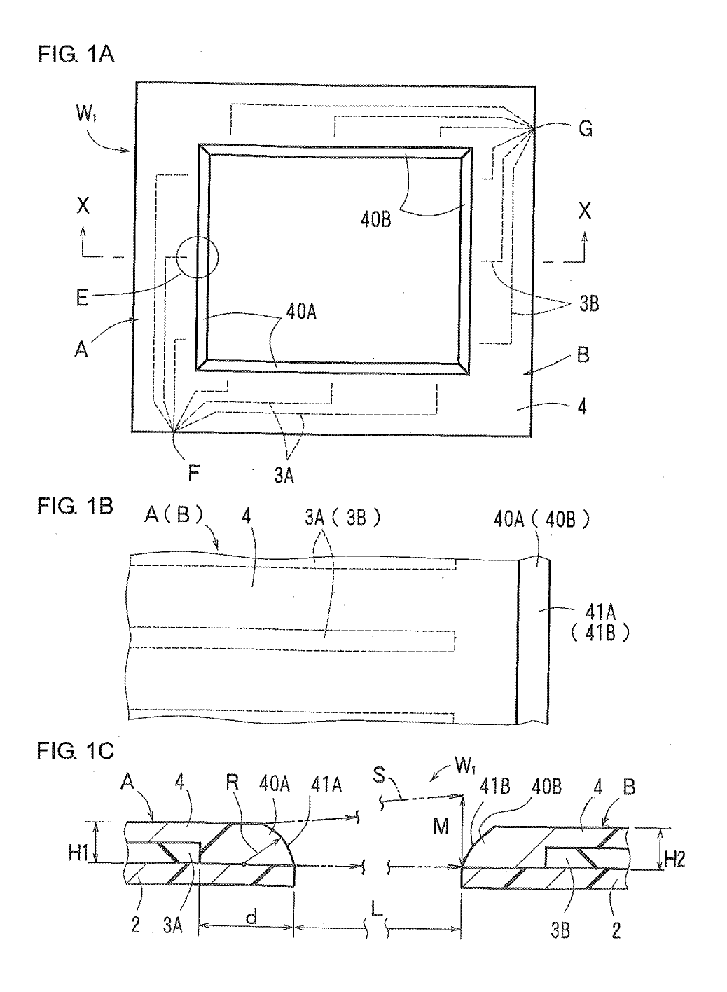

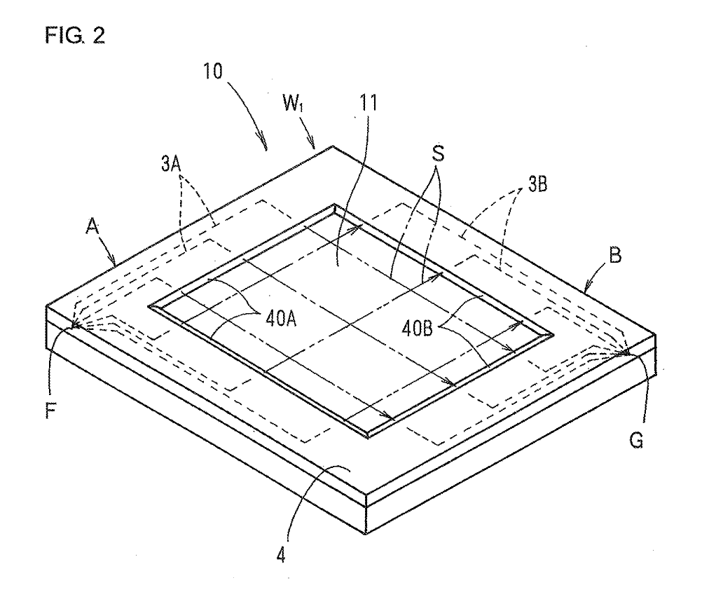

FIGS. 1A to 1C show an optical waveguide W₁ for a touch panel according to a first preferred embodiment. As shown in FIG. 1A, the optical waveguide W₁ according to the first preferred embodiment is in the form of a rectangular frame as seen in plan view. One L-shaped section constituting the rectangular frame is a light-emitting optical waveguide section A, and the other L-shaped section is a light-receiving optical waveguide section B. The optical waveguide W₁ includes an under cladding layer 2 in the form of a rectangular frame, and a plurality of cores 3A and 3B serving as a passageway for light and provided on predetermined portions of a surface of the under cladding layer 2. The cores 3A and 3B are patterned to extend from predetermined portions F and G provided at outer end edges of the respective L-shaped sections to inner end edges of the respective L-shaped sections (on a display screen side of a display 11 with reference to FIG. 2) and to be arranged in a parallel, equally spaced relationship. The number of cores 3A provided in the light-emitting optical waveguide section A is equal to the number of cores 3B provided in the light-receiving optical waveguide section B. End surfaces at ends of the light-emitting cores 3A respectively are in face-to-face relationship with end surfaces at ends of the light-receiving cores 3B. In FIG. 1A, the cores 3A and 3B are indicated by broken lines, and the thickness of the broken lines indicates the thickness of the cores 3A and 3B. Also, the number of cores 3A and 3B are shown as abbreviated.

FIG. 1B is an enlarged view of a portion enclosed with a circle E of FIG. 1A, and FIG. 1C is an enlarged sectional view taken along the line X-X of FIG. 1A. As shown in FIGS. 1B and 1C, an over cladding layer 4 is provided on the surface of the under cladding layer 2 so as to cover the cores 3A and 3B. In the first preferred embodiment, edges of the over cladding layer 4 are extended to form lens portions 40A and 40B which cover the end surfaces of the light-emitting and light-receiving cores 3A and 3B lying at inner end edges of the L-shaped sections. The light-emitting lens portion 40A and the light-receiving lens portion 40B are equal in height, and are sized to be equal to the thickness of the over cladding layer 4. The lens portions 40A and 40B have respective lens surfaces 41A and 41B that are arcuately curved surface as seen in vertical sectional view (with reference to FIG. 1C). These light-emitting and light-receiving components (i.e., the cores 3A and 3B, and the lens portions 40A and 40B), which are identical in structure with each other, are shown by the same drawing in FIG. 1B.

A light beam S emitted from the light-emitting lens portion 40A is adapted to diffuse (diverge) gradually in the direction of the height of the lens portion 40A (in a vertical direction) as the light beam S travels, as shown in FIG. 1C. Preferably, the vertical width of the light beam S satisfies the following relations (1) to (3).

M=H1×(1+a×L/100) (1)

0<a≦5 (2)

H1=H2 (3)

where H1 is the height of the light-emitting lens portion 40A in millimeters, H2 is the height of the light-receiving lens portion 40B in millimeters, L is a distance between edges of the light-emitting and light-receiving lens portions 40A and 40B in millimeters, and M is a vertical width of a light beam S emitted from the light-emitting lens portion 40A as measured at the edge of the light-receiving lens portion 40B in millimeters. Specifically, the light beam S emitted from the light-emitting lens portion 40A is preferably adapted to diffuse in the direction of the height of the lens portion 40A so that the vertical width M of the light beam S is greater than 1.0 times the height H1 of the lens portion 40A and is not greater than 1.5 times the height H1 as measured at a position spaced a distance of ten times the height H1 apart from the edge of the lens portion 40A, for example. The diffusion (divergence) of the light beam S is set by adjusting a distance d from a light-emitting surface of a light-emitting core 3A to the edge of the light-emitting lens portion 40A, and the radius of curvature R of the curved lens surface 41A of the light-emitting lens portion 40A as appropriate. In this manner, the emitted light beams S are diffused in the vertical direction. This accommodates warpage or distortion, if any, in the optical waveguide W₁ to achieve proper optical transmission. It should be noted that the emitted light beam S in the first preferred embodiment is diffused also in a horizontal direction (in a direction perpendicular to the height or vertical direction).

As shown in FIG. 2, the optical waveguide W₁ in the form of the rectangular frame is provided along the rectangular shape of the periphery of the display screen of the rectangular display 11 of a touch panel 10 so as to surround the display screen of the rectangular display 11. In the predetermined portion F provided at an outer end edge of the light-emitting optical waveguide section A, a light source (not shown) such as a light-emitting element is connected to ends of the cores 3A. In the predetermined portion G provided at an outer end edge of the light-receiving optical waveguide section B, a detector (not shown) such as a light-receiving element is connected to ends of the cores 3B. In FIG. 2, the cores 3A and 3B are indicated by broken lines, and the thickness of the broken lines indicates the thickness of the cores 3A and 3B in a manner similar to that in FIG. 1A. Also, the number of cores 3A and 3B are shown as abbreviated. Only some of the multiple light beams S are shown in FIG. 2 for ease of understanding.

In the light-emitting optical waveguide section A, light beams S emitted from the light source travel through the cores 3A, and exit the end surfaces of the cores 3A. Thereafter, the light beams S pass through and exit the lens portion 40A at the edge of the over cladding layer 4 in front of the end surfaces of the cores 3A. At this time, the diffusion of the light beams S in the vertical direction is optimized as described above by refraction resulting from the lens surface 41A (with reference to FIG. 1C) of the lens portion 40A. Then, the light beams S travel over the display screen of the display 11 (with reference to FIG. 2) toward the light-receiving optical waveguide section B.

In the light-receiving optical waveguide section B, on the other hand, the light beams S having traveled over the display screen of the display 11 (with reference to FIG. 2) enter the lens surface 41B (with reference to FIG. 1C) of the lens portion 40B at the edge of the over cladding layer 4, and are narrowed down and converged in the vertical direction by refraction resulting from the lens surface 41B of the lens portion 40B. Then, while being converged, the light beams S travel from the end surfaces of the cores 3B into the cores 3B, and are detected by the detector (not shown).

Such transmission of the light beams S is done in the optical waveguide W₁ shown in FIG. 2. Thus, as shown in FIG. 2, the light beams S diffuse gradually in the vertical direction (upwardly as seen in FIG. 2) over the display screen of the display 11 of the touch panel 10 as the light beams S travel from the light-emitting optical waveguide section A toward the light-receiving optical waveguide section B. In that state, the light beams S travel in a lattice form (although only some of the light beams S forming the lattice are shown in FIG. 2 for ease of understanding). This enables the light-receiving lens portion 40B to lie within a light-receiving region if warpage or distortion occurs in the optical waveguide W₁. Thus, when a portion of the display screen of the display 11 is touched with a finger, the position of the portion touched with the finger is accurately detected.

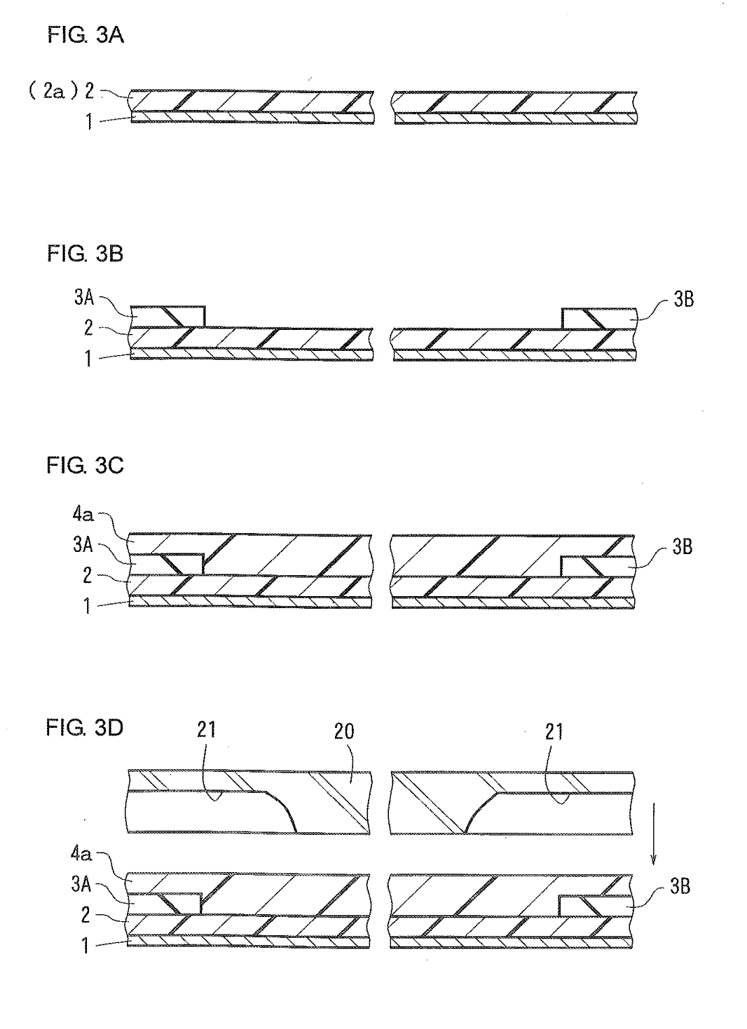

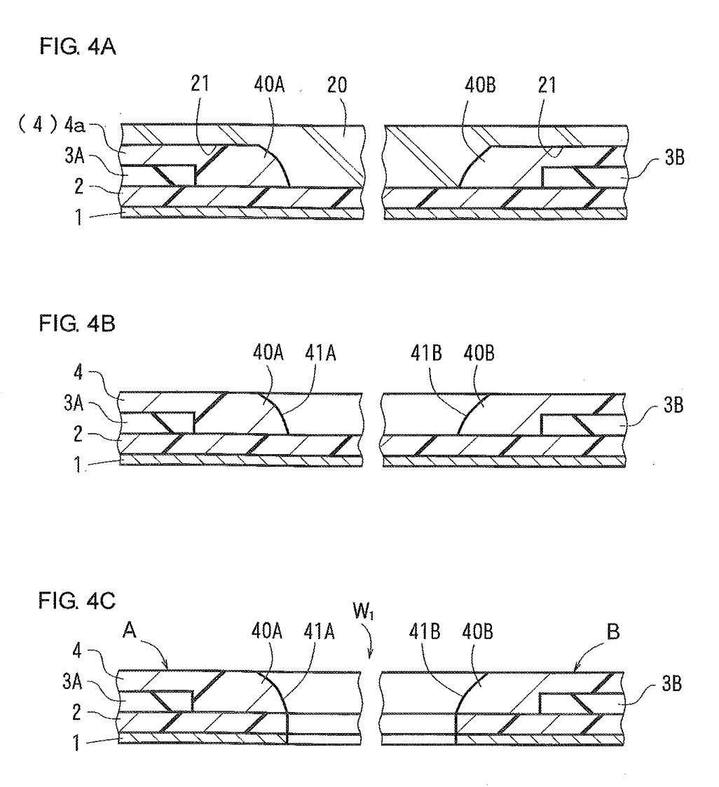

Next, an example of a method of manufacturing the optical waveguide W₁ will be described with reference to FIGS. 3A to 3D and FIGS. 4A to 4C which mainly illustrate the opposed lens portions 40A and 40B shown in FIGS. 1A to 1C and a peripheral portion thereof.

First, a base 1 of a flat shape (with reference to FIG. 3A) for use in the manufacture of the optical waveguide W₁ is prepared. Examples of a material for the formation of the base 1 include glass, quartz, silicon, resin, and metal. The base 1 has a thickness, for example, in the range of 20 μm to 5 mm.

Then, as shown in FIG. 3A, the under cladding layer 2 is formed on a surface of the base 1. Examples of a material for the formation of the under cladding layer 2 include thermosetting resins and photosensitive resins. When a thermosetting resin is used, a varnish prepared by dissolving the thermosetting resin in a solvent is applied to the base 1, and a layer of the applied varnish is then heated to thereby form the under cladding layer 2. When a photosensitive resin is used, on the other hand, a varnish prepared by dissolving the photosensitive resin in a solvent is applied to the base 1, and a layer of the applied varnish is then exposed to irradiation light such as ultraviolet light to thereby form the under cladding layer 2. The under cladding layer 2 has a thickness, for example, in the range of 5 to 70 μm.

Next, as shown in FIG. 3B, the cores 3A and 3B having a predetermined pattern are formed on a surface of the under cladding layer 2 by a photolithographic method. Preferably, a photosensitive resin excellent in patterning characteristics is used as a material for the formation of the cores 3A and 3B. Examples of the photosensitive resin include UV-curable acrylic resins and UV-curable epoxy resins. These resins are used either singly or in combination. Examples of the sectional configuration of the cores 3A and 3B include a trapezoid and a rectangle having excellent patterning characteristics. The cores 3A and 3B have a width, for example, in the range of 10 to 100 μm, and a thickness (height), for example, in the range of 25 to 100 μm.

The material for the formation of the cores 3A and 3B used herein has a refractive index higher than that of the material for the formation of the under cladding layer 2 described above and the over cladding layer 4 to be described below (with reference to FIG. 1C). The adjustment of the refractive index may be made, for example, by adjusting the selection of the types of the materials for the formation of the under cladding layer 2, the cores 3A and 3B and the over cladding layer 4, and the composition ratio thereof.

Then, as shown in FIG. 3C, a photosensitive resin to be formed into the over cladding layer 4 is applied to the surface of the under cladding layer 2 so as to cover the cores 3A and 3B to form a photosensitive resin layer 4a (uncured). An example of the photosensitive resin to be formed into the over cladding layer 4 includes a photosensitive resin similar to that for the under cladding layer 2.

Then, as shown in FIG. 3D, a mold 20 for press molding the over cladding layer 4 into the shape of the rectangular frame is prepared. This mold 20 is made of a material (for example, quartz) permeable to irradiation light such as ultraviolet light, and includes a cavity having a mold surface 21 complementary in shape to the surface of the over cladding layer 4 including the lens portions 40A and 40B.

Then, as shown in FIG. 4A, the mold 20 is pressed against the photosensitive resin layer 4a so that the mold surface 21 (the cavity) of the mold 20 is positioned in a predetermined location relative to the cores 3A and 3B, to mold the photosensitive resin layer 4a into the shape of the over cladding layer 4. Next, the photosensitive resin layer 4a is exposed to irradiation light such as ultraviolet light through the mold 20 in that state. Thereafter, a heating treatment is performed. The exposure and the heating treatment are carried out in a manner similar to those performed in the method for the formation of the under cladding layer 2 described with reference to FIG. 3A.

Thereafter, the mold 20 is removed, as shown in FIG. 4B. This provides the over cladding layer 4 in the form of a rectangular frame which includes the lens portions 40A and 40B. The over cladding layer 4 has a thickness (as measured from the surface of the under cladding layer 2) generally in the range of 50 to 2000 μm.

Thereafter, as shown in FIG. 4C, the under cladding layer 2 together with the base 1 is cut into the shape of a rectangular frame by punching using a blade and the like. In this manner, the optical waveguide W₁ in the form of the rectangular frame which includes the under cladding layer 2, the cores 3A and 3B, and the over cladding layer 4 is manufactured on the surface of the base 1. The optical waveguide W₁ is used after being stripped from the base 1 (with reference to FIG. 1C).

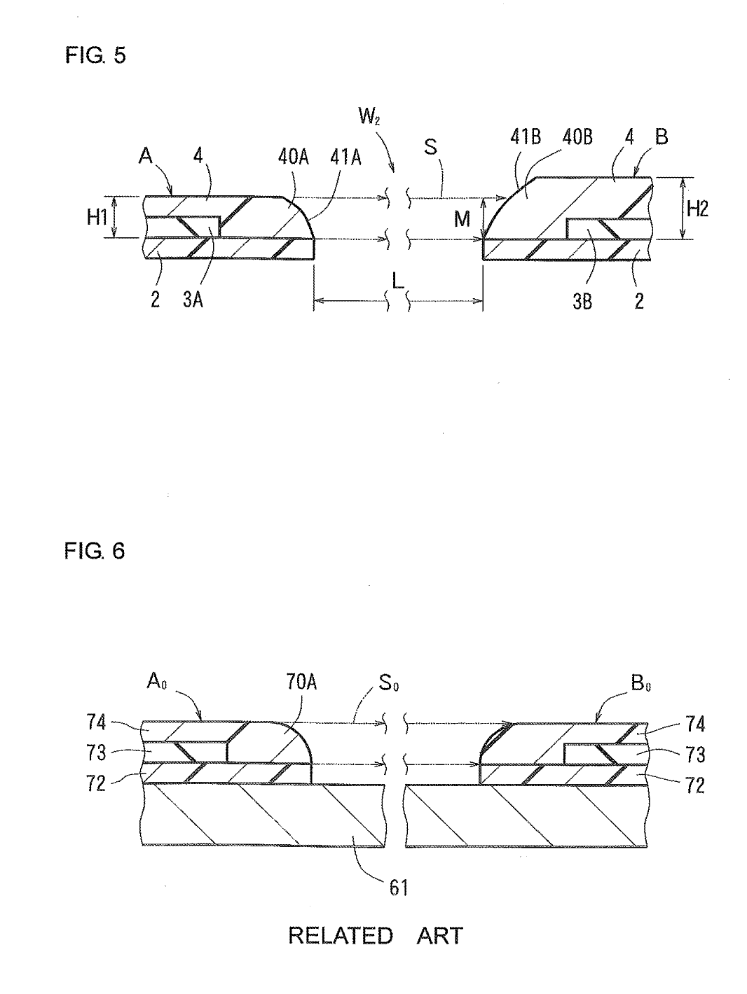

FIG. 5 shows an optical waveguide W₂ for a touch panel according to a second preferred embodiment. In the optical waveguide W₂ according to the second preferred embodiment, the height H2 of the light-receiving lens portion 40B is greater than the height H1 of the light-emitting lens portion 40A.

A light beam S emitted from the light-emitting lens portion 40A is adapted to be collimated, as shown in FIG. 5, rather than to diffuse in the vertical direction. It should be noted that the emitted light beam S in the second preferred embodiment is diffused in a horizontal direction (in a direction perpendicular to the height or vertical direction). Other parts of the second preferred embodiment are similar to those of the first preferred embodiment. Like reference numerals and characters are used to designate parts similar to those of the first preferred embodiment.

Preferably, the height H2 of the light-receiving lens portion 40B satisfies the following relations (4) to (6).

H2=H1×(1+a×L/100) (4)

0<a≦5 (5)

H1=M (6)

where H1 and H2 are in millimeters, L is a distance between edges of the light-emitting and light-receiving lens portions 40A and 40B in millimeters, and M is a vertical width of a light beam S emitted from the light-emitting lens portion 40A as measured at the edge of the light-receiving lens portion 40B in millimeters. Specifically, for example, when the distance L between the edges of the light-emitting and light-receiving lens portions 40A and 40B is ten times the height H1 of the light-emitting lens portion 40A, the height H2 of the light-receiving lens portion 40B is preferably greater than the height H1 of the light-emitting lens portion 40A so as to be greater than 1.0 times the height H1 and to be not greater than 1.5 times the height H1.

In the second preferred embodiment, light beams S emitted from the lens portion 40A of the light-emitting optical waveguide section A are not diffused in the vertical direction but are collimated by refraction resulting from the lens surface 41A of the lens portion 40A. Also, the height H2 of the light-receiving lens portion 40B is greater than the height H1 of the light-emitting lens portion 40A (the vertical width M of the collimated light beam S). This enables the light-receiving lens portion 40B to lie within the light-receiving region if warpage or distortion occurs in the optical waveguide W₂. Thus, the position of a portion of the display screen of the display 11 touched with a finger is accurately detected in the touch panel 10 (with reference to FIG. 2).

In the first and second preferred embodiments, the photosensitive resin is used to form the under cladding layer 2. However, in place of the photosensitive resin, a resin film functioning as the under cladding layer 2 may be prepared and used as it is as the under cladding layer 2. Alternatively, in place of the under cladding layer 2, a substrate with a metal film formed on the surface thereof may be used as a body having a surface on which the cores 3A and 3B are to be formed.

Although the optical waveguides W₁ and W₂ are in the form of the rectangular frame in the first and second preferred embodiments, each of the optical waveguides W₁ and W₂ in the form of the rectangular frame may be divided into the two L-shaped optical waveguide sections constituting each of the optical waveguides W₁ and W₂. A manufacturing method thereof may include the step of cutting the under cladding layer 2 together with the base 1 into two L-shaped sections in place of the step of cutting the under cladding layer 2 together with the base 1 into the shape of the rectangular frame. Further, at least one of the two L-shaped optical waveguide sections may be subdivided into linear optical waveguide sections constituting the at least one section.

Also, the optical waveguides W₁ and W₂ in the first and second preferred embodiments are used after being stripped from the base 1. However, the optical waveguides W₁ and W₂ still provided on the surface of the base 1 may be used without being stripped therefrom.

Next, an inventive example of the pre sent invention will be described in conjunction with a comparative example. It should be noted that the present invention is not limited to the inventive example.

### EXAMPLES

A ray tracing simulation was performed using optical simulation software known as “LIGHTTOOLS” available from Optical Research Associates. Settings of a simulation model of a light-emitting optical waveguide section were as follows:

### [Simulation Model]

Over cladding layer: a refractive index of 1.50; a thickness of 1 mm; and a lens portion height of 1 mm.

Cores: a refractive index of 1.57; a thickness of 50 μm; and a width of 15 μm.

Under cladding layer: a refractive index of 1.50; and a thickness of 15 μm.

Distance of 4.04 mm from light-emitting surfaces of the cores to an edge of a lens portion.

In the simulation model, when the radius of curvature R of a curved lens surface of the lens portion was 1.4 mm (when Sample 1 having R=1.4 mm was prepared), light beams emitted from the curved lens surface were not diffused in a vertical direction but were collimated (so as to have a vertical width of 1 mm). When the radius of curvature R was 1.5 mm and 1.6 mm (when Sample 2 having R=1.5 mm and Sample 3 having R=1.6 mm were prepared), light beams emitted from the curved lens surface were diffused in the vertical direction. The vertical widths of the light beams in Samples 2 and 3 were 1.2 mm and 1.5 mm, respectively, as measured at a position spaced a distance of 10 mm apart from the edge of the lens portion.

A light-receiving surface (having a height of 1 mm and a width of 20 mm) corresponding to a light-receiving lens portion was set at a position 100 mm ahead of the edge of the lens portion in the simulation model.

[Optical Transmission Loss Resulting from Warpage]

The optical transmission loss at the light-receiving surface was simulated, while the lens portion in the simulation model was inclined upwardly and downwardly with respect to a horizontal direction (with an inclination angle of 0 degrees). The lens portion was inclined upwardly and downwardly to an angle of six degrees in steps of one degree.

The result was that the optical transmission loss increased as the inclination angle increased in Samples 1 to 3. However, Sample 1 in which the emitted light beams were collimated light beams was smaller in the increase in optical transmission loss than Samples 2 and 3 in which the emitted light beams were diffused.

[First Optical Transmission Loss Resulting from Vertical Misregistration]

The simulation model was held in a horizontal position. In this state, the optical transmission loss at the light-receiving surface was simulated, while the light-receiving surface was moved upwardly. The light-receiving surface was moved upwardly to a distance of 1.0 mm in steps of 0.2 mm.

The result was that the optical transmission loss increased as the amount of movement of the light-receiving surface increased in Samples 1 to 3. However, Sample 1 in which the emitted light beams were collimated light beams was smaller in the increase in optical transmission loss than Samples 2 and 3 in which the emitted light beams were diffused.

The result shows that an optical waveguide for a touch panel in which emitted light beams are diffused in the vertical direction is capable of causing light beams emitted from the light-emitting lens portion to sufficiently enter a light-receiving optical waveguide section if warpage or distortion occurs in the optical waveguide itself.

[Second Optical Transmission Loss Resulting from Vertical Misregistration]

The simulation model in Sample 1 in which the emitted light beams were collimated light beams was held in a horizontal position, and the light-receiving surface was moved 0.1 mm upwardly. In this state, the illuminance of light beams received by the light-receiving surface was simulated, while the height (vertical width) of the light-receiving surface was increased from 1.0 mm to 2.0 mm in steps of 0.2 mm. Also, the light-receiving surface was moved 0.1 mm downwardly. In this state, the illuminance of light beams received by the light-receiving surface was simulated, while the height of the light-receiving surface was increased in a similar manner.

The result was that the illuminance of the light beams received by the light-receiving surface increased as the height of the light-receiving surface increased in either case.

The result shows that an optical waveguide for a touch panel in which the height of the light-receiving lens portion is greater than that of the light-emitting lens portion is capable of causing light beams emitted from the light-emitting lens portion to sufficiently enter the light-receiving optical waveguide section if warpage or distortion occurs in the optical waveguide itself.

Although specific forms of embodiments of the instant invention have been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention.

The optical waveguide for a touch panel is applicable to an optical waveguide for use as a detection means (a position sensor) for detecting a finger touch position and the like in a touch panel.

What is claimed is:

1. An optical waveguide for a touch panel, comprising:
cores; and
an over cladding layer which covers the cores,
the optical waveguide configured to be disposed along the periphery of a display screen of a display of a touch panel,
wherein the cores includes a light-emitting core for emitting a light beam and a light-receiving core for receiving the light beam,
wherein the light-emitting core has an end surface positioned on one side of the display screen of the display,
wherein the light-receiving core has an end surface positioned on the other side of the display screen of the display,
wherein the over cladding layer includes a first edge covering the end surface of the light-emitting core and configured in the form of a light-emitting lens portion having an outwardly-bulging arcuately curved surface as seen in vertical sectional view, and a second edge covering the end surface of the light-receiving core and configured in the form of a light-receiving lens portion having an outwardly-bulging arcuately curved surface as seen in vertical sectional view, and
wherein the light-emitting lens portion has one of the following configurations: a first configuration in which a light beam emitted from the light-emitting lens portion is adapted to diffuse in the direction of the height of the light-emitting lens portion; and a second configuration in which the height of the light-emitting lens portion is less than the light of the light-receiving lens portion.

2. The optical waveguide according to claim 1, wherein the first configuration of the light-emitting lens portion satisfies
M=H1×(1+a×L/100)
0<a≦5
H1=H2
where H1 is the height of the light-emitting lens portion in millimeters, H2 is the height of the light-receiving lens portion in millimeters, L is a distance between edges of the light-emitting and light-receiving lens portions in millimeters, and M is a vertical width of a light beam emitted from the light-emitting lens portion as measured at the edge of the light-receiving lens portion in millimeters.

3. The optical waveguide according to claim 1, wherein the second configuration of the light-emitting lens portion satisfies
H2=H1×(1+a×L/100)
0<a≦5
H1=M
where H1 is the height of the light-emitting lens portion in millimeters, H2 is the height of the light-receiving lens portion in millimeters, L is a distance between edges of the light-emitting and light-receiving lens portions in millimeters, and M is a vertical width of a light beam emitted from the light-emitting lens portion as measured at the edge of the light-receiving lens portion in millimeters.

4. The optical waveguide according to claim 1, wherein the vertical width of a light beam emitted from the light-emitting lens portion is set based on a distance from a light-emitting surface of the light-emitting core to the edge of the light-emitting lens portion, and the radius of curvature of the arcuately curved surface of the light-emitting lens portion.

5. The optical waveguide according to claim 2, wherein the vertical width of a light beam emitted from the light-emitting lens portion is set based on a distance from a light-emitting surface of the light-emitting core to the edge of the light-emitting lens portion, and the radius of curvature of the arcuately curved surface of the light-emitting lens portion.
